(19) United States
(12) Patent Application Publication
(10) Pub. No.: US 2011/0166293 A1
(43) Pub. Date: Jul. 7, 2011

(54) COMPOSITION CONTAINING (METH)ACRYLIC POLYMER AND COPOLYMER HAVING ASSOCIATIVE GROUPS

(75) Inventors: Nicolas Dufaure, Bernay (FR); François-Genes Tournilhac, Paris (FR); Manuel Hidalgo, Brignais (FR); Ludwik Leibler, Paris (FR)

(73) Assignees: Arkema France, Colombes (FR); CNRS, Paris (FR)

(21) Appl. No.: 12/999,337

(22) PCT Filed: Jun. 12, 2009
(86) PCT No.: PCT/FR2009/051113

§ 371 Date: Feb. 28, 2011

(30) Foreign Application Priority Data
Jun. 17, 2008 (FR) 0853982

(51) Int. Cl. C08L 79/08; C08L 33/12; C08L 35/00; C08L 33/02; C08L 33/06; C08L 33/20

(52) U.S. Cl. 525/69; 525/55; 525/186; 525/207; 525/221; 525/228; 525/238

(57) ABSTRACT

The present invention relates to a composition containing at least one (meth)acrylic polymer and at least one copolymer containing motifs from at least one first monomer (A), enabling compatibility with said (meth)acrylic polymer, and at least one second motif (B) carrying an associative group. The invention also relates to the use of such a copolymer having associative groups to improve the properties of a (meth)acrylic polymer. The invention also relates to uses of the abovementioned composition.

The present invention relates to novel chemical compositions based on (meth)acrylic polymer and on copolymer carrying associative groups.

“Supramolecular” materials are materials composed of compounds held together by noncovalent bonds, such as hydrogen, ionic and/or hydrophobic bonds. They can in particular be polymers to which associative groups are grafted, which groups are capable of linking up via cooperative hydrogen bonds. One advantage of these materials is that these physical bonds are reversible, in particular under the influence of the temperature or by the action of a selective solvent. The ease of processing and/or the properties of the polymers, such as the mechanical, rheological, thermal, optical, chemical or physicochemical properties, can thus be improved by the grafting of these associative groups. The latter can also confer the properties of polymers of high weight on polymers of lower Weight which are easier to process.

The document U.S. Pat. No. 2,980,652 thus discloses a product resulting from the reaction of a unit carrying imidazolidone associative groups with a copolymer resulting from the copolymerization of certain monomers comprising anhydride functional groups, maleic anhydride or itaconic anhydride or citraconic anhydride, with at least one unsaturated ethylenic monomer. It is indicated that this product has good adhesion to metals, glass and plastics. Example 9 discloses more particularly the product of the reaction of N-aminoethyl-2-imidazolidone (UDETA) with a copolymer of maleic anhydride and of methyl methacrylate. This product is formulated in a varnish which can be sprayed over steel panels (Examples 14 and 15).

Furthermore, the document WO 2006/016041 discloses polymers grafted with associative groups which make it possible to confer thereon a higher elastic modulus and a better resistance to solvents. In this document, macromolecular chains carry associative groups. Two main methods of preparation make it possible to obtain such materials.

In one case, a polymer carrying reactive groups (such as acid, epoxy or anhydride groups) is grafted with a molecule carrying an associative group based on imidazolidone and a reactive group (amine, alcohol, and the like). This grafting can be carried out either by the solvent route or during a reactive extrusion stage. This process can thus be applied only to polymers carrying reactive functional groups.

A second route consists in introducing reactive groups during the polymerization stage. Methacrylic monomers carrying associative groups are used as comonomers. In comparison with the method described above, this technique makes it possible to obtain a broader choice of (meth)acrylic polymers carrying associative groups. Nevertheless, the direct modification by copolymerization, in order to be optimal, implies good control of the molecular weights and of the molecular weight distribution, and also of the level and distribution of associative groups in the modified chains, which is often complicated and expensive. This type of process also involves an extensive industrial organization, the achievement of polymers grafted with associative groups of different masses and different degrees of grafting involving many grades.

In this context, the Applicant Company has been interested in the means which make it possible to modify (meth)acrylic polymers, such as PMMA, by supramolecular chemistry for the purpose of improving their properties, without trying to modify all or virtually all of the macromolecular chains of the material.

It is to the credit of the Applicant Company to have developed a chemical composition which makes it possible to result in a material of supramolecular type based on (meth)acrylic polymer which exhibits improved properties while retaining a majority of the polymer chains free from associative groups. In order to achieve this aim, the Applicant Company has devised an “indirect modification” of a (meth)acrylic polymer, such as PMMA, by blending, during the processing thereof, with a copolymer rich in monomers which, after polymerization, give blends compatible with the (meth)acrylic polymer and further carrying associative groups. It is thus possible to obtain a highly compatible homogeneous blend of polymers and to indirectly convey associative groups into a (meth)acrylic polymer for the purpose of conferring various properties thereon.

The choice of (meth)acrylic polymers which can be modified is thus very broad and can be made by simple blending. The user desiring to modify such a polymer thus does not have to proceed directly to a reactive extrusion of the polymer to be modified or to carry out a copolymerization directly in order to obtain the desired modification but much more simply to add, to his (meth)acrylic polymer material to be modified, such as PMMA, a copolymer rich in monomers which, after polymerization, give blends compatible with the (meth)acrylic polymer and further carrying associative groups.

More specifically, it has been demonstrated that the polymer carrying associative groups makes it possible to confer, on the (meth)acrylic polymer to be modified, such as PMMA, improved properties of resistance to creep and to solvents and can optionally contribute thereto, in addition, improved thermal properties, in particular a higher glass transition temperature. This can be obtained without modifying the viscoelastic behavior of the (meth)acrylic material at the forming temperatures.

It has also been demonstrated that the content of associative groups can be reduced, with respect to the processes for modifying all of the chains, to obtain similar properties.

A subject matter of the present invention is thus a composition comprising at least one (meth)acrylic polymer and at least one copolymer including units resulting from at least one first monomer (A) which makes possible the compatibility with said (meth)acrylic polymer and including at least one second unit (B) carrying an associative group.

The term “(meth)acrylic polymer” is understood to mean, within the meaning of the invention, an acrylic polymer or a methacrylic polymer. The (meth)acrylic polymer can in particular be a homo- or copolymer based on methyl methacrylate. It is generally a thermoplastic polymer. The (meth)acrylic polymer can be a copolymer, one of the comonomers of which is methyl methacrylate.

A preferred example of (meth)acrylic polymer is poly(methyl methacrylate) or PMMA and its copolymers, sometimes also called PMMA when the level of methyl methacrylate in the copolymer is predominant. Such a polymer is sold in particular by Arkema under the trade name Altuglas®. Other (meth)acrylic polymers which can be used in this invention can be the poly(acrylic acid) homopolymer, the poly(methacrylic acid) homopolymer and the homopolymers of their esters, such as, for example, poly(butyl acrylate), poly(2-ethylhexyl acrylate), poly(methyl acrylate), poly(ethyl acrylate), poly(polyethylene glycol methacrylate) or poly-(methoxypolyethylene glycol methacrylate), the poly-(acrylonitrile) homopolymer, and also their copolymers including at least 2 of the monomers mentioned in brackets. It is also possible for the (meth)acrylic polymer according to the invention to be a blend including at least 2 of the above (meth)acrylic polymers or copolymers. The (meth)acrylic polymer according to the invention described in this paragraph will generally be referred to simply as (meth)acrylic polymer in that which follows.

PMMA or its copolymers is preferred for use in the present invention.

The (meth)acrylic polymer can be obtained according to suspension, microsuspension, emulsion or bulk polymerization processes well known to a person skilled in the art.

It can represent from 1 to 99.5% by weight, and preferably from 5 to 99.5% by weight, froze 10 to 99.5% by weight, from 20 to 99.5% by weight, from 30 or from 40 to 99.5% by weight and even from 50 to 99% by weight, with respect to the total weight of the composition according to the invention.

This (meth)acrylic polymer can be formulated in a composition resulting, after processing, in a final material, preferably rigid and transparent, which can comprise one or more additives described in more detail below.

This (meth)acrylic polymer is combined, in the composition according to the invention, with a copolymer carrying associative groups in order to form a “compound”.

This copolymer carrying associative groups includes units of at least one first monomer (A) which render said copolymer compatible with said (meth)acrylic polymer and includes at least one second unit (B) carrying an associative group. The monomer (A) preferably represents at least 20 mol % of the copolymer. The copolymer carrying associative groups according to the invention will generally be referred to simply as “copolymer” in that which follows.

The term “compatible” is understood to mean that the (meth)acrylic polymer and the copolymer form homogeneous blend, in the sense that they exhibit a miscibility such that the (meth)acrylic polymer is swollen by the copolymer or that the (meth)acrylic polymer swells the copolymer, in the proportions used in the blend. This is reflected in that the (meth)acrylic polymer and the copolymer form only a single phase. Depending on the nature of the copolymer and in particular on the monomer (A) used for the synthesis thereof, the compatibility within the meaning of the invention with the (meth)acrylic polymer can be obtained in variable proportions of the blend of the two polymers, ((meth)acrylic polymer and copolymer carrying associative groups). This compatibility can be demonstrated by physical measurements of miscibility.

This miscibility can be pinpointed by various analytical methods known to a person skilled in the art, such as scanning electron microscopy (SEM), transmission electron microscopy (TEM) or atomic force microscopy (AFM), often making it possible to locate inhomogeneities of the blends in the form of domains with a characteristic size of greater than 1 micron (immiscibility), and by measurements of the glass transition temperature Tg of the blend of the two polymers the miscibility is then reflected by the existence of a single Tg for the blend. The methods for measuring the Tg of the polymers and of the blends of polymers are known to a person skilled in the art and include differential scanning calorimetry (DSC), volumetric analysis or dynamic mechanical analysis (DMA). It is also possible to determine the miscibility by optical measurements, such as the transparency. When the miscibility is determined by transparency measurements in noncrystalline polymer systems, such as PMMA, the difference in transparency between that of a test specimen or sheet of the blend, with a thickness of 2 to 4 mm, and the transparency of a test specimen or sheet of the blend of the (meth)acrylic polymer alone and with the same thickness, should not be perceptible to the naked eye; in other words, when the blend is not compatible within the meaning of the invention, there appears, in comparison with the sample of the (meth)acrylic polymer alone, a veil or an opacity sufficiently perceptible to the eye and easily quantifiable by optical transparency measurements known to a person skilled in the art (such as the percentage of transmission or the percentage of haze).

Thus, any copolymer carrying associative groups and which is compatible, within the meaning explained above, with the (meth)acrylic polymer can be used for the invention, in particular any copolymer based on a monomer (A) for which the corresponding homopolymer is known to be miscible with the (meth)acrylic polymer or for which the presence of units resulting from the monomer (A) results in the compatibility with the (meth)acrylic polymer.

The choice of the monomer (A) of the copolymer carrying associative groups depends on the composition of the (meth)acrylic polymer according to the invention.

According to the invention, it is thus possible to blend a (meth)acrylic polymer with a copolymer carrying associative groups of very different molecular weight, such that they combine the advantages of these two types of polymers.

According to the invention, it is thus possible to blend a (meth)acrylic polymer (polymer 1) with a copolymer carrying associative groups (polymer 2) of very different molecular weight, such as to combine the advantages of these two types of polymers. More particularly, if polymer 1 of weight W1 is blended with a low proportion of polymer 2 of molecular weight W2, with W2>W1, it is possible to obtain a material having a viscosity at low gradient which is substantially higher than that of polymer 1, whereas the viscosity at high gradient remains not much greater than that of polymer 1.

This situation is advantageous from the viewpoint of the processes for processing plastics when it is desired to obtain both a relatively low viscosity at the forming velocities and a high melt strength.

This method also makes it possible to have improved properties of impact strength and of resistance to solvents by using relatively low contents of copolymer carrying associative groups (polymer 2).

Mention may be made, as nonexclusive examples of monomers (A), of methyl methacrylate, acrylic acid, methacrylic acid, acrylic acid esters, methacrylic acid esters, acrylonitrile or maleic anhydride. Mention may be made, as examples of copolymers carrying associative groups which can be blended, at variable proportions according to their nature and that of the (meth)acrylic polymer, with the (meth)acrylic polymer in order to obtain the compatibility and the “indirect modification” effects via reversible physical bonds according to the invention, of methyl methacrylate copolymers (referred to as copolymers of PMMA type) carrying associative groups, maleic anhydride copolymers carrying associative groups or acrylonitrile copolymers carrying associative groups, and more generally of all the polymers resulting from the abovementioned monomers.

The term “associative groups” is understood to mean groups capable of associating with one another via hydrogen bonds, advantageously via 1 to 6 hydrogen bonds. Examples of associative groups which can be used according to the invention are the imidazolidinyl, triazolyl, triazinyl, bis-ureyl or ureido-pyrimidyl groups, the imidazolidinyl groups being preferred.

According to one embodiment of the invention, the associative groups can be introduced during the formation of the copolymer. This embodiment is not limiting, it also being possible to envisage a reactive extrusion of a blend of associative groups with the preformed (meth)acrylic polymer.

The copolymer is thus capable of being obtained by copolymerization of the monomer (A) with a monomer (B) Which carries associative groups and optionally one or more other monomers, preferably starting from:
on the one hand, a monomer (A) which is a monomer for which the corresponding homopolymer is known to be miscible with the (meth)acrylic polymer or for which the presence of units resulting from the monomer (A) results in the compatibility with the (meth)acrylic polymer, this monomer being chosen from: methyl methacrylate, acrylic acid, methacrylic acid, acrylic acid esters, methacrylic acid esters, acrylonitrile and maleic anhydride,
on the other hand, a monomer (B) carrying associative groups, preferably imidazolidinyl groups, which is advantageously chosen from: ethylimidazolidone methacrylate (or EIOM) and ethylimidazolidone methacrylamide,
optionally one or more other monomers chosen from acrylic acid or methacrylic acid, their esters, their amides or their salts, itaconic acid, its esters, its amides or its salts, styrene and its derivatives, such as 4-styrenesulfonate.

In a preferred embodiment of the composition, the (meth)acrylic polymer is poly(methyl methacrylate) and the copolymer including units resulting from a monomer (A) is methyl methacrylate. Thus, the composition can comprise a blend of PMMA and of PMMA carrying associative groups.

Such a copolymer can be prepared according to known methods of radical polymerization in solution in solvents, such as chloroform or tetrahydrofuran, or in dispersed medium, such as, in particular, in aqueous suspension or emulsion. Preferably, the copolymer used in the invention can be obtained by radical polymerization in aqueous suspension or emulsion. In the case of polymerizations in solution or in aqueous suspension, the polymerization can be initiated using initiators of radical polymerization which are soluble in the mixture of monomers. Different mechanisms for generating radicals can be employed, such as, for example, thermal decomposition, oxidation/reduction reactions or the decomposition brought about by electromagnetic radiation and in particular the light in the ultraviolet region. Nonexclusive examples of initiators include hydroperoxides, dialkylperoxides, diacylperoxides, peroxy esters, peroxydicarbonates, peroxyacetals, azo compounds and their combinations with agents which promote their decomposition, such as amines and metal atoms.

Mention may be made, as examples of hydroperoxides, of tert-butyl hydroperoxide, tert-amyl hydroperoxide, cumyl hydroperoxide, 2,5-dimethyl-2,5-di(hydroperoxy)-hexane, diisopropylbenzene monohydroperoxide and para-menthane hydroperoxide.

Mention may be made, as examples of dialkyl peroxides, of 2,5-dimethyl-2,5-di(tert-butylperoxy)hex-3-yne, di-(tert-butyl)peroxide, di(tert-amyl)peroxide, 1,3-di(tert-butylperoxyisopropyl)benzene, 2,5dimethyl-2,5-di(tert-butylperoxy)hexyne, 1,1,4,4,7,7-hexamethyl-cyclo-4,7-diperoxynonane or 3,3,6,6,9,9-hexamethyl-cyclo-1,2,4,5-tetraoxanonane.

Mention may be made, as examples of diacyl peroxides, of benzoyl peroxide, lauroyl peroxide decanoyl peroxide, 3,5,5-trimethylhexanoyl peroxide or acetyl cyclohexylsulfonyl peroxide.

Mention may be made, as examples of peroxy esters, of tert-butyl peroxybenzoate, tert-butyl peroxyacetate, tent-butyl peroxy-3,5,5-trimethylhexanoate, tert-amyl peroxy-3,5,5-trimethylhexanoate, 2,5-dimethyl-2,5-di-(benzoylperoxy)hexane OO-tert-butyl O-isopropyl mono-peroxycarbonate, OO-tert-butyl O-(2-ethylhexyl) mono-peroxycarbonate, tert-butyl peroxyisobutyrate tert-butyl peroxy-2-ethylhexanoate, tert-amyl peroxy-2-ethylhexanoate, 2,5-dimethyl-2,5-di(2-ethylhexanoyl-peroxy)hexane, tert-butyl peroxyneodecanoate, tert-butyl peroxyisononanoate, tert-butyl peroxypivalate, tert-amyl peroxypivalate, α-cumyl peroxyneodecanoate, tert-amyl peroxydecanoate, tert-butyl 3-hydroxy-1,1-dimethylbutylperoxyneodecanoate and tert-butyl peroxymaleate.

Mention may be made, as examples of peroxydicarbonates, of di(2-ethylhexyl) peroxydicarbonate, dicyclohexyl peroxydicarbonate, di(n-propyl) peroxydicarbonate or di(4-(tert-butyl)cyclohexyl)peroxydicarbonate.

Mention may be made, as examples of peroxyacetals, of 1,1-di(tert-butylperoxy)cyclohexane, 1,1,-di(tert-butylperoxy)-3,3,5-trimethylcyclohexane, ethyl 3,3-di(tert-butylperoxy)butyrate, ethyl 3,3-di(tert-amyl-peroxy)butyrate, n-butyl 4,4-di(tert-butylperoxy)-valerate, 2,2-di(tert-butylperoxy)butane, 1,1-di(tert-amylperoxy)cyclohexane or 2,2-bis[4,4-di(tert-butyl-peroxy)cyclohexyl]propane.

Mention may be made, as examples of azo compounds, of 2,2′-azobisisobutyronitrile or 2-[(E)-(1-cyano-1-methylethyl)diazenyl]-2-methylpropanenitrile, 2-[(E)-(1-cyano-1-methylpropyl)diazenyl]-2-methylbutanenitrile or azobismethylbutyronitrile, azobisisobutyramide, dimethyl azobisdiisobutyrate, diethyl azobisisobutyrate, or cyanovaleric acid or 4-[(E)-(3-carboxy-1-cyano-1-methylpropyl)diazenyl-4-cyanopentanoic acid.

The polymerization can also be initiated with initiators/controllers of controlled radical polymerization such as alkoxyamines, and more particularly with 2-methyl-2-[N-(tert-butyl)-N-(1-diethoxyphoshoryl-2,2-dimethylpropyl)aminoxy]propionic acid of following formula:

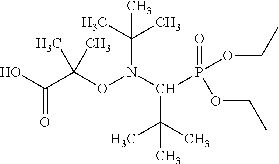

sold, by Arkema under the BlocBuilder® brand, and its metal or organic salts.

These initiators can be used at a level of 0.05 to 10% by weight, with respect to the total weight of the monomers.

In the case of the polymerizations in organic solution or in aqueous suspension or emulsion, in addition to the polymerization initiators, it may prove to be of use to dissolve other additives in the monomers, among which additives may be mentioned chain-transfer agents which make it possible to reduce the molecular weights. Mention may be made, as examples of chain-transfer agents, of alkyl mercaptans, such as methyl mercaptan, ethyl mercaptan, n-propyl mercaptan, isopropyl mercaptan, n-butyl mercaptan, tert-butyl mercaptan, cyclohexyl mercaptan, benzyl mercaptan, n-octyl mercaptan, tert-nonyl mercaptan, n-dodecyl mercaptan or tert-dodecyl mercaptan, or alkyl thioglycolates, such as methyl thioglycolate, ethyl thioglycolate, 2-ethylhexyl thioglycolate or isooctyl thioglycolate. The chain-transfer agents are used in proportions of between 0.01 and 10% by weight and preferably between 0.5 and 2% by weight, with respect to the total weight of the monomers.

In the case of the polymerizations in organic solution or in a dispersed medium, such as aqueous suspension or emulsion polymerization, it is also possible to dissolve other additives in the monomers, such as antioxidants, for example butylated hydroxytoluene BHT, biocides or activators of polymerization initiators. These additives are used in proportions of between 0.01 and 5% by weight, with respect to the total weight of the monomers.

In the case of the polymerizations in aqueous suspension, the mixture of the monomers comprising the polymerization initiator and optionally other additives dissolved in this mixture is dispersed in a continuous aqueous phase comprising a suspending agent which promotes the stability of the suspension during the polymerization. Mention may be made, among suspending agents which can be used, as nonexclusive example, of finely divided mineral powders, such as talc or calcium triphosphate, polymers which are suspending agents, sometimes also known as protective colloids, such as partially or completely hydrolyzed polyvinyl alcohols, copolymers of styrene and of (meth)acrylic acid, with or without a third monomer, such as α-methylstyrene, some surfactants, such as sorbitan ethoxylated esters, thickening water-soluble polymers, such as hydroxyethylcellulose, polymers and copolymers based on (meth)acrylic acid or its salts, polymers and copolymers based on (meth)acrylamide and its derivatives, or polyacrylamidopropanesulfonate. The suspending agents are used in proportions ranging from 0.05 to 10% by weight and preferably from 0.1 to 5% by weight, with respect to the total weight of the dispersed phase comprising the monomers. In combination with the suspending agents, other additives added to the aqueous phase, such as salts, for example sodium sulfate or ammonium sulfate, sometimes known as “extenders”, which make it possible to control the ionic strength of the medium, or pH regulators, such as sodium bicarbonate, can be used in proportions ranging from 0.05 to 5% by weight, with respect to the total weight of the continuous aqueous phase.

In the case of the polymerizations in an aqueous emulsion, water-soluble radical polymerization initiators are used. Different mechanisms for generating radicals can be employed such as, for example, thermal decomposition, oxidation/reduction reactions or the decomposition brought about by electromagnetic radiation and in particular the light in the ultraviolet region. Nonexclusive examples of water-soluble initiators include hydroperoxides, such as tert-butyl hydroperoxide, water-soluble azo compounds, such as 2,2′-azobis(2-amidinopropane)dihydrochloride and organic or inorganic salts of 4,4′-azobis(4-cyanovaleric acid), or inorganic oxidizing agents, such as sodium persulfate, potassium persulfate or ammonium persulfate, aqueous hydrogen peroxide solution, perchlorates, percarbonates or ferric salts; these oxidizing agents can be used alone or in combination with inorganic or organic reducing agents, such as sodium bisulfite, sodium metabisulfite, potassium bisulfite or potassium metabisulfite, vitamin C, or sodium hypophosphite or potassium hypophosphite. These organic or inorganic reducing agents can also be used alone, that is to say in the absence of inorganic oxidizing agents. These initiators which are soluble in the aqueous phase are used in the case of the emulsion polymerizations in proportions ranging from 0.01 to 10% by weight, with respect to the total weight of the monomers.

In the case of the polymerizations in aqueous emulsion, surfactants or stabilizers which make it possible to form the starting emulsions and to stabilize the final latexes obtained can be used. Three families of surfactants or stabilizers can be considered, namely:
1) surface-active molecules of natural or synthetic origin having a dispersing and stabilizing effect by electrostatic repulsion and comprising amphiphilic molecules which are positively or negatively charged, or which form zwitterions (amphoteric), in the aqueous phase, among which may be mentioned, as nonexclusive examples: sodium or potassium alkyl sulfates or alkylsulfonates, in particular sodium dodecyl sulfate, sodium or potassium alkylaryl sulfates or alkylarylsulfonates, in particular sodium dodecylbenzenesulfonate, potassium, sodium or ammonium salts of fatty acids, in particular sodium stearate, alkylated and disulfonated diphenyl oxides, in particular the commercial surfactants of the Dowfax® range, such as Dowfax® 2A1, sulfosuccinates and in particular the commercial surfactant's of the Aerosol® range, such as Aerosol® MA 80, which is sodium dihexyl sulfosuccinate, or Aerosol® OT-75, which is dioctyl sodium sulfosuccinate, phosphoric esters, fatty amines, polyamines and their salts, quaternary ammonium salts, such as alkyltrimethylammonium chlorides or bromides, betaines, such as N-alkyl betaines or sulfobetaines, imidazoline carboxylates, and the ethoxylated derivatives of all these compounds,
2) uncharged or nonionic surface-active molecules having dispersing and stabilizing effect by steric repulsion, among which may be mentioned, as nonexclusive examples: ethoxylated alkylphenols, ethoxylated fatty alcohols, polyethylene oxide and polypropylene oxide block copolymers, such as those of the Pluronics range, fatty acid esters or alkyl polyglycosides,
3) charged or uncharged amphiphilic or completely hydrophilic polymeric molecules, among which may be mentioned, as nonexclusive examples: water-soluble polymers of natural or synthetic origin, such as polymers and copolymers of (meth)acrylic acid and their salts, polymers and copolymers of acrylamide and its derivatives, polymers based on vinyl alcohol and vinyl acetate, hydroxyethylcellulose and hydrophobically modified hydroxyethylcellulose, polyvinylcaprolactam or polyvinylpyrrolidone.

These dispersants or stabilizers used in emulsion polymerization are present at a level of 0.1 to 10% by weight, with respect to the total weight of the monomers. It is also possible to carry out emulsion polymerizations in the absence of surfactants or stabilizing or dispersing agents; in this specific case, the final proportions of polymer, expressed in terms of final solids content or final dry extract, that is to say after evaporation of the volatiles and in particular of the water, are less than 20% by weight of the total of the latex resulting from the emulsion polymerization.

The solution processes, on the one hand, and the aqueous suspension or emulsion processes, on the other hand, which can be used for the synthesis of the copolymers carrying the associative groups according to the invention can be carried out at atmospheric pressure or under pressure and at polymerization temperatures of between 5° C. and 180° C. Preferably, the copolymer is obtained by an aqueous suspension or emulsion process at atmospheric pressure and polymerization temperatures of between 50 and 95° C. The final concentrations or concentrations after polymerization of polymer and other nonvolatile components for the polymerizations in a solution, aqueous suspension or aqueous emulsion are between 1 and 75% by weight and preferably between 15 and 50% by weight, expressed as final dry extract or final solids content, with respect to the total weight of the solution, suspension or emulsion (latex).

The process for the synthesis of the copolymer can be continuous or batchwise or of semicontinuous type, that is to say with metered additions of components, such as, for example, metered additions of monomers, as is or preemulsified, as is often the case in aqueous emulsion polymerizations, or metered additions of additives, such as dispersants or stabilizers, initiators or other additives.

Generally, the preferred aqueous suspension and aqueous emulsion processes used to obtain the copolymer carrying the associative groups according to the invention are well known to a person skilled in the art and are described in general and specialist works, such as, for example, in Chapter 7 of the book Les latex synthétiques: Elaboration, Propriétés, Applications [Synthetic Latexes: Preparation, Properties and Applications], edited by C. Pichot and J. C. Daniel (Editions TEC&DOC of Lavoisier, France, 2006).

In another embodiment of the invention, the copolymer can be obtained by grafting the associative groups to a copolymer, already formed, comprising, in addition to the monomer (A), a monomer (B′) including at least one reactive functional group, such as an acid, anhydride, alcohol, mercaptan, amine, epoxy or isocyanate functional group, preferably an anhydride functional group, by reaction of one or more modifying agents carrying, on the one, hand, an associative group and, on the other hand, a reactive group chosen from amine, mercaptan, epoxy, isocyanate, anhydride or alcohol groups, preferably an amine group, said reactive group being capable of forming a covalent bond with said reactive functional group.

In this embodiment, the copolymer carrying reactive functional groups can, for example, be an alkyl (meth)acrylate homo- or copolymer, for example having a number-average molecular weight ranging from 1000 to 10 090 000 g/mol and preferably from 5000 to 100 000 g/mol, including anhydride functional groups. This copolymer can be obtained from a copolymer of alkyl(meth)acrylate, in particular methyl(meth)acrylate, and of (meth)acrylic acid, such as the Altuglas® HT 121 grade from Arkema, for example including between 1 and 15 mol % of (meth)acrylic acid units, according to a cyclization process, under basic catalysis conditions, which can in particular be carried out in an extruder. The preferred basic Catalysts include sodium hydroxide and sodium methoxide, CH₃ONa. The cyclization can be carried out by passing the starting copolymer with the catalyst and optionally other additives, such as lubricants, antioxidants, dyes or optical correctors, to give gloss and reduce yellowing, through a single- or twin-screw extruder; the extrusion temperature can be between 200 and 300° C. and preferably greater than 250° C. One or more extrusion passes can be carried out in order to obtain the desired level of cyclization (formation of glutaric anhydride). The degree of cyclization can be controlled in order to adjust the level of anhydride functional groups obtained, which can, for example, range from 0.1 to 20 mol %.

The reactive and associative groups respectively of the modifying agent can be separated by a rigid or flexible chain composed of 1 to 30 carbon atoms, some at least of which can be substituted, and optionally of one or More heteroatoms chosen in particular from sulfur, oxygen and nitrogen, said chain optionally including one or more ester or amide bridges. It is preferably a linear or branched C₁-C₁₀ alkylene chain optionally interrupted by one or more nitrogen atoms, more preferably a linear C₁-C₆ alkylene chain.

Preferred examples of modifying agents are 1-(2-aminoethyl)imidazolidin-2-one (UDETA), 1-(2-[(2-aminoethyl)amino]ethyl)imidazolidone (UTETA), 1-(2-{2-[(2-aminoethylamino)]ethylamino}ethyl)imidazolidone (UTEPA), 3-amino-1H-1,2,4-triazole (3-ATA) and 4-amino-1H-1,2,4-triazole (4-ATA). UDETA is preferred for use in the present invention.

The amines carrying imidazolidone functional groups can themselves result from the reaction of urea with at least one compound chosen from alkyleneamines and amines. Thus, UDETA can be prepared by reacting urea with diethylenetriamine (DETA).

The number of associative groups carried by the copolymer in this embodiment according to the invention can be simply adjusted by varying the amount of modifying agent or the reaction time and reaction temperature. It is generally preferable for the amount of modifying agent to represent from 0.5 to 15% by weight, more preferably from 1 to 5% by weight, with respect to the weight of the copolymer carrying reactive functional groups, and/or for the mean number of associative groups per copolymer chain to be between 1 and 200 and preferably between 1 and 30.

The grafting process is carried out by reacting the modifying agent and the copolymer carrying reactive functional groups. This stage can be carried out in the molten state, for example in an extruder or an internal mixer, at a temperature which can range from 150 to 300° C. and preferably from 200 to 280° C. The modifying agent is blended with the polymer, alone or using an additive which makes possible the impregnation of the solid polymer grains with the premelted modifying agent. The solid blend, before introduction into the extruder or the mixer, can be rendered more homogeneous by cooling in order to cause the modifying agent to solidify. It is also possible to meter the latter into the extruder or the mixer after the polymer to be grafted has started melting. The time at the grafting temperature can range from a few seconds to 5 minutes. The modifying agent can be introduced into the extruder in the form of a masterbatch in a polymer which can be the polymer to be grafted. According to this method of introduction, the masterbatch can comprise up to 30% by weight of the modifying agent; subsequently, the masterbatch is “diluted” in the polymer to be grafted during the grafting operation. According to another possibility, the grafting can be carried out by reaction in a solvent phase, for example in anhydrous chloroform. In this base, the reaction temperature can range from 5 to 75° C., for times ranging from a few minutes to a day, and at concentrations of polymer before grafting of between 1 and 50% by weight, with respect to the total weight of the solution.

The copolymer carrying associative groups obtained according to one or other of the above embodiments can be provided in particular in the form of granules or of a powder. It is blended with the (meth)acrylic polymer described above by any means, in particular by calendaring, extrusion, melt blending in a mixing chamber, pressing, injection molding or dissolution in a common solvent, followed by separation of the solvent.

The level of copolymer carrying associative groups represents, for example, from 0.1 to 75% by weight of this blend, for example from 1 to 40% by weight in the case of PMMA.

It has been demonstrated that this copolymer makes it possible to improve some mechanical and chemical properties of the (meth)acrylic polymer with which it is blended.

Another subject matter of the present invention is thus the use of a copolymer carrying associative groups as is described above for improving one or more of the following properties of a (meth)acrylic polymer: its creep strength, in particular at more than 25° C., its glass transition temperature (Tg), its Vicat softening point, its adhesion to metal surfaces, such as surfaces made Of steel or aluminum, its elongation at break, in particular at more than 25° C., its melt strength or melt elongational viscosity, its chemical resistance, its processability, its surface hardness, its scratch resistance or its resistance in stress cracking tests.

Stress cracking is a term used to describe a phenomenon of chemical attack of a product which acts on polymeric material in a way which is scarcely perceptible when this material is not subjected to mechanical stress. However, contact of the material With the product brings about the formation microcracks. When the material is then placed under stress, propagation of the microcracks occurs, resulting in embrittlement of the material and in failure of the latter.

Apart from the copolymer carrying the associative groups according to the invention, the composition according to the invention can additionally include various additives, including
lubricants, such as stearic acid, palmitic acid or stearyl alcohol,
dyes,
inorganic or organic pigments, such as those described in the document “Plastics Additives and Modifiers Handbook, Section VIII, Colorants”, J. Edenbaum, Ed., Van Nostrand, pages 884-954. Mention may be made, as examples of pigments which can be used, of carbon black, titanium dioxide, clay, metal particles or treated mica particles of the Iriodin® brand sold by Merck,
heat stabilizers, such as tert-dodecyl disulfide (DtDDS), Irganox 1076 or Tinuvin P,
UV stabilizers, such as those described in the document “Plastics Additives and Modifiers Handbook, Chap. 16, Environmental Protective Agents”, J. Edenbaum, Ed., Van Nostrand, pages 208-271. Preferably, the UV stabilizer is a compound of the family of the HALS, triazines, benzotriazoles or benzophenones. Use may be made of combinations of several UV stabilizers in order to obtain a better resistance to UV radiation,
costabilizers,
antioxidants, for example hindered phenols, such as the compounds Irganox 1010 and 1098 from Ciba, phosphites and HALS,
fillers or reinforcements, in particular cellulose fillers, talc, calcium carbonate mica or wollastonite, glass or metal oxides or hydrates,
antistatic agents such as amine derivatives and phosphoric esters,
fungicides and biocides,
impact modifiers, such as MBS copolymers, including Clearstrength® from Arkema, and acrylic modifiers of core-shell type, such as the Durastrength® products from Arkema, and also those described in international application WO 06/053984,
flame retardants, including antimony trioxide, zinc borate and brominated or chlorinated phosphate esters, and those described in patent application EP 1 777 257,
flattening agents, which can be inorganic fillers, such as, for example, talc, calcium carbonate, titanium dioxide or zinc oxide, or inorganic fillers, such as, for example, crosslinked beads based on styrene and/or MMA (examples of such beads are given in EP 1 174 465),
solvents, and
their mixtures.

These additives can, for example, represent from 0.1 to 50% of the total weight of the composition.

In addition to the solid form, this composition can be provided in particular in the form of emulsions, of suspensions or of solutions.

The composition according to the invention can be used to manufacture components used in the motor vehicle industry, such as signal lights or dashboards, in the construction and building industry, such as windows or window frames, in decoration, such as furniture or jewelry, in hygiene/health, such as bathtubs, wash basins or test tubes, in domestic electrical appliances, such as microwave oven doors or mixer bowls, in office automation and electronics, such as portable telephone screens and optical disks (DVD, CD-ROM, and the like), in lighting, such globes and diffusers, in signing, such as signs and displays, or in the cosmetics field, for the production of bottles.

Another subject matter of the invention is thus the abovementioned uses.

This composition can be formed by calendering, extrusion, extrusion-blow molding, injection molding, rotational molding, thermoforming, and the like.

### BRIEF DESCRIPTION OF THE DRAWINGS

A better understanding of the invention will be obtained in the light of the following examples, given solely for illustrative purposes, and by reference to the appended figures, in which:

FIG. 1 represents the complex viscosity of the polymers V825T and HT121 and of two compositions formed of a blend of PMMA and PMMA copolymer carrying associative groups or of PMMA and PMMA copolymer without associative groups, in 90/10 ratios,

FIG. 2 represents the complex viscosity of the polymers V825T and HT121 and of two compositions formed of a blend of PMMA and PMMA copolymer carrying associative groups or of PMMA and PMMA copolymer without associative groups, in 75/25 ratios.

FIG. 3 represents the strain in a creep test at 100° C. under a stress of 10 MPa for compositions formed of a blend of PMMA and PMMA copolymer carrying associative groups or of PMMA and PMMA copolymer without associative groups, and also for the polymer V825T.

FIG. 4 represents the change in the normalized stress during the stress cracking test for the compositions formed of a blend of PMMA and PMMA copolymer carrying associative groups or of PMMA and PMMA copolymer without associative groups, and also for the polymer V825T.

### EXAMPLES

### Example 1

### Preparation of a Copolymer According to the Invention by Grafting of Associative Groups

A modifying agent, namely UDETA carrying an imidazolidinyl associative group and an amine reactive group, was grafted to a copolymer of methyl methacrylate, of methacrylic acid and of glutaric anhydride. This copolymer is itself obtained by partial cyclization of a copolymer of methyl methacrylate and of methacrylic acid. The cyclization reaction can be carried out in the molten state in an extruder or any other appropriate mixer with optionally the help of a basic catalyst, such as sodium hydroxide. This reaction can also be carried out in an oven under high vacuum. The grafting reaction on the copolymer carrying the glutaric anhydride functional groups can subsequently be carried out either in the molten state, in an extruder or any other appropriate mixer, or in solution in an appropriate solvent, such as chloroform.

Specifically, a copolymer of methyl methacrylate and of methacrylic acid sold by Arkema under the name Altuglas® HT121 (copolymer comprising approximately 5% by weight of methacrylic acid comonomer) was partially cyclized by placing it in an oven under vacuum at 235° C. for 24 hours. The acid groups of the starting copolymer have a tendency to cyclize to more than 90% by reaction either with a neighboring, acid group (departure of water) or with a neighboring methyl ester group (departure of methanol). The copolymer thus obtained is subsequently grafted with UDETA by extrusion of the cyclized copolymer as a blend with UDETA in a DSM twin-screw microextruder equipped with a recirculation pipe and with a capacity of 15 g. The rotational speed of the screws is set at 200 revolutions per minute and the temperature at 230° C.; flushing with nitrogen makes it possible to prevent the materials from decomposing. The UDETA is introduced in a proportion of 4.5% by weight, with respect to the copolymer/UDETA combination. The residence time of the polymer/UDETA blend in the microextruder is set at 5 minutes. This modified polymer is denoted hereinbelow by “HT121g”.

### Example 2

### Preparation of Compositions According to the Invention

The sample HT121g obtained in Example 1 and the product HT121 were each blended in a proportion of 10% and 20% by weight with the same PMMA (sold by Arkema under the name Altuglas® V825T). The blends are produced in the same microextruder as that mentioned in Example 1, at a temperature of 230° C., while flushing with nitrogen and for 5 minutes. The stirring speed is adjusted to 200 revolutions per minute.

The 4 formulations obtained are summarized in Table 1.

TABLE 1

| Percentages by | | | | Tg |
|---|---|---|---|---|
| weight | V825T | HT121 | HT121g | (° C.) |
| Composition 1 | 90 | 10 | | 117 |
| Composition 2 | 75 | 25 | | 118.5 |
| Composition g1 | 90 | | 10 | 118 |
| Composition g2 | 75 | | 25 | 117.5 |

This table also exhibits the Tg values of the blends measured by DSC at 10° C./min using a DSC Q1000 from TA Instruments operating in the T4 mode. For each blend, just one Tg can be identified. The Tg values of V825T, HT121 and HT121g were measured under the same conditions respectively at 114.5, 122 and 122° C. The Tg values of the blends, which are sole values and between the Tg values of the 2 materials constituting the blend, indicate that the blends are highly miscible.

### Example 3

### Rheological Measurements

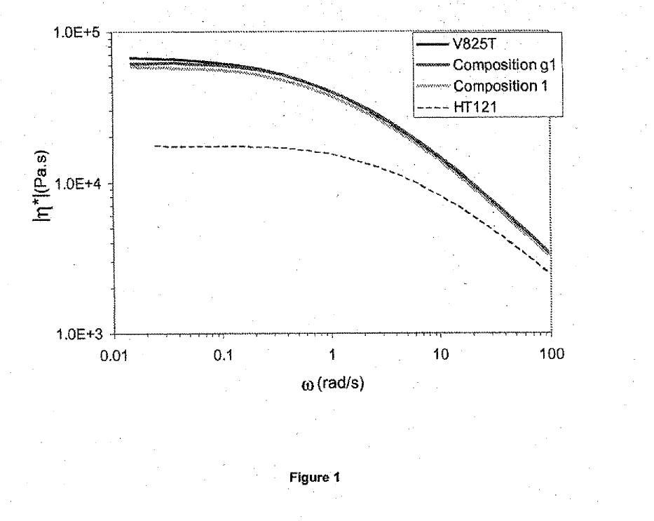

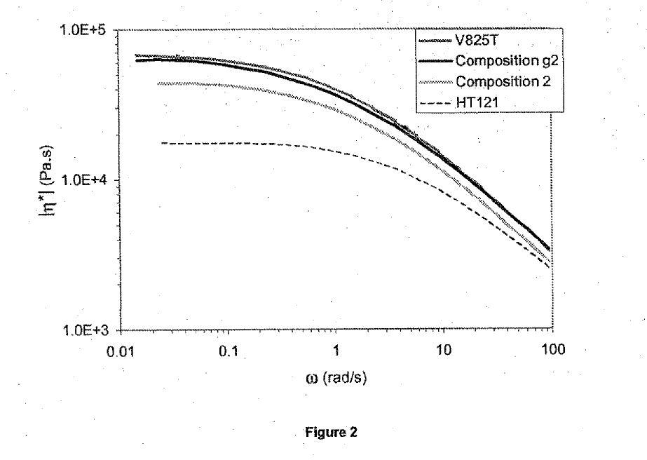

Compositions 1, 2, g1 and g2, and the polymers V825T and HT121, were subjected to rheological measurements at 160° C. An Ares rheometer from Rheometric Scientific, equipped with parallel plates with a diameter of 25 mm, was used. The samples were dried at 105° C. under vacuum for 16 hours before the test in order to prevent the formation of bubbles during the experiments. Frequency sweeps were carried out between 100 and 0.01 rad/s, the strains being sufficiently low to remain within the linear domain. The modulus of the complex viscosity for the 6 products studied is represented in FIGS. 1 and 2.

It is observed that the addition of the PMMA copolymer carrying associative groups is not reflected by an increase in viscosity with respect to V825T. Compositions g1 and g2 will thus have a forming very comparable to that of V825T.

### Example 4

### Creep Tests

Compositions 1, 2, g1 and g2 and the polymer V825T were subjected to a creep test at 100° C.

4A Protocol

The test consists in imposing a constant stress, in cantilever bending, on the test material and in measuring the change in the resulting strain over time. For a given stress, the greater the creep strength of the material, the lower the strain over time. The sample is composed of the central part of a tensile test specimen, injected using a DACA microinjector operating with a hold pressure of 12 bar. The temperatures of the barrel and of the mold were respectively set at 285° C. and 110° C. The sample is a parallelepiped with a length of 25 mm, a width of 4 mm and a thickness of 1.5 mm. The test is carried out using a DMA 2980 from TA Instruments equipped with Cantilever bending geometry. The temperature is set at 100° C. and, after leaving the sample in the oven for 5 minutes in order to equilibrate the temperature, a stress of 10 MPa is applied for 3 hours. The resulting strain of the sample is measured over time.

4B Results

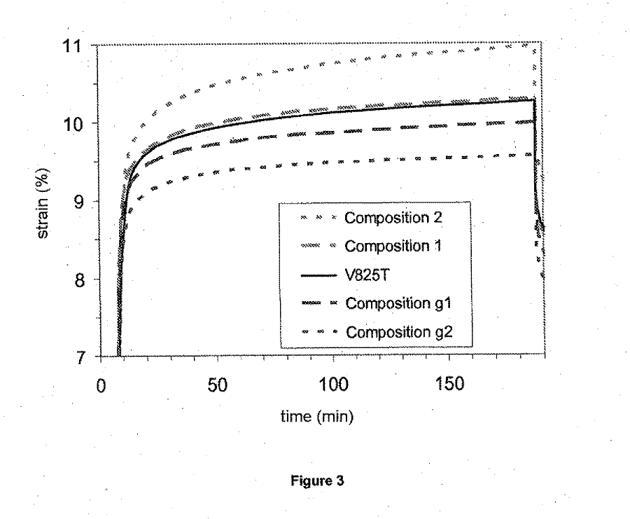

As illustrated in FIG. 3, Compositions g1 and g2, including the copolymer carrying associative groups according to the invention, exhibit a better creep strength than the PMMA V825T alone. The creep curves for Compositions 1 and 2 prove that this effect is not due to the HT121; on the contrary, the latter ungrafted polymer results in a deterioration in the creep strength properties.

### Example 5

### Stress Cracking Tests

Compositions 1, 2, g1 and g2 and the polymer V825T were subjected to a stress cracking test at ambient temperature.

5A Protocol

The stress cracking test combines the action of solvent and of a stress. This is an important test for polymer materials as a large part of the defects observed during the use of these materials is due to this two-fold stress-solvent action. More specifically, the test carried out consists in imposing, in the presence of a solvent, a constant strain in three-point bending on the test material. The times for failure of the sample or for the appearance of cracks are measured. The change in the stress during the test can also be recorded. The deterioration of the sample is represented by these failure/crack phenomena and by the speed of the fall in stress during the test. The most resistant products are thus those with the longest decomposition times or with the greater stability of the stress during the test. The sample is prepared according to the same procedure as that described in Example 4. The test is carried out using an item of equipment designed in the laboratory: a controlled strain Ares rheometer provided with a normal force sensor is equipped with three-point bending geometry, where the length of the sample between the two extreme points is 24.25 mm. The strain is set at 1.6% using the displacement control of the rheometer and the stress is calculated from the normal force recorded by the rheometer. A plastic pipe conveys, from a syringe mounted on a syringe driver, the solvent to be deposited on the surface of the sample. As soon as the desired strain is reached, a drop of solvent (mixture of equal weights of water and ethanol) is deposited on the sample. A droplet is subsequently deposited every two minutes in order to compensate for the losses due to evaporation. A camera connected to a computer makes it possible to record the change in the surface appearance of the sample over time.

5B Results

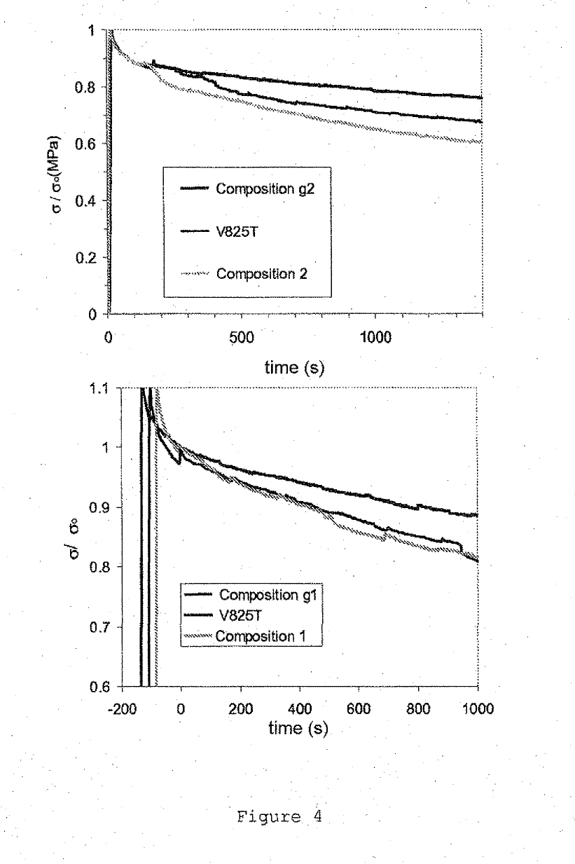

It is observed, in particular in FIG. 4, that the relaxation of the stresses is lower for the blends with HT121g1 and that the cracks are much fewer for these same compositions, with respect to the reference product V825T. It may thus be concluded that Composition g1 exhibits a better stress cracking resistance than V825T and than Composition 1, and Composition g2 also exhibits a better resistance than V825T and than Composition 2. The compositions including the copolymer carrying associative groups according to the invention thus exhibit a better resistance to the combined action of a solvent and of a stress than the PMMA V825T alone. The creep curves of Compositions 1 and 2 prove that this effect is not due to the HT121; on the contrary, the latter ungrafted polymer results in a deterioration in the stress cracking resistance properties.

1. A composition comprising at least one (meth)acrylic polymer and at least one copolymer including units resulting from at least one first monomer (A) which makes possible the compatibility with said (meth)acrylic polymer and including at least one second unit (B) carrying an associative group.

2. The composition as claimed in claim 1, wherein the (meth)acrylic polymer is chosen from either poly(methyl methacrylate) or a copolymer, one of the comonomers of which is methyl methacrylate.

3. The composition as claimed in claim 1, wherein the (meth)acrylic polymer represents from 10 to 99.5% by weight, with respect to the total weight of the composition.

4. The composition as claimed in claim 1, wherein the (meth)acrylic polymer represents from 50 to 99% by weight, with respect to the total weight of the composition.

5. The composition as claimed in claim 1, wherein the monomer (A) represents at least 20 mol % of the copolymer.

6. The composition as claimed in claim 1, wherein the associative groups are chosen from imidazolidinyl, triazolyl, triazinyl, bis-ureyl and ureido-pyrimidyl groups, preferably an imidazolidinyl group.

7. The composition as claimed in claim 1, wherein said monomer (A) is a monomer for which the corresponding homopolymer is known to be miscible with the (meth)acrylic polymer or for which the presence of units resulting from the monomer (A) results in the compatibility with the (meth)acrylic polymer, this monomer being chosen from: methyl methacrylate, acrylic acid, methacrylic acid, acrylic acid esters, methacrylic acid esters, acrylonitrile and maleic anhydride.

8. The composition as claimed in claim 1, wherein the copolymer is capable of being obtained by grafting the associative groups to a copolymer, already formed, comprising, in addition to the monomer (A), a monomer (B′) including at least one reactive functional group, such as an acid, anhydride, alcohol, mercaptan, amine, epoxy or isocyanate functional group, preferably an anhydride functional group, by reaction of one or more modifying agents carrying, on the one hand, an associative group and, on the other hand, a reactive group chosen from amine, mercaptan, epoxy, isocyanate, anhydride or alcohol groups, preferably an amine group, said reactive group being capable of forming a covalent bond with said reactive functional group.

9. The composition as claimed in claim 8, wherein the copolymer including the monomer (B′) is capable of being obtained by cyclization of a copolymer of alkyl(meth)acrylate and of (meth)acrylic acid under basic catalysis conditions.

10. The composition as claimed in claim 1, wherein the copolymer is capable of being obtained by polymerization starting from:
on the one hand, a monomer (A) which is a (meth)acrylic monomer chosen from:
methyl methacrylate, acrylic acid, methacrylic acid, butyl acrylate, 2-ethylhexyl acrylate, methyl acrylate, ethyl acrylate, methoxypolyethylene glycol methacrylate, acrylonitrile and maleic anhydride,
on the other hand, a monomer (B) carrying associative groups, preferably imidazolidinyl groups, which is advantageously chosen from: ethylimidazolidone methacrylate and ethylimidazolidone methacrylamide, and
optionally one or more other monomers chosen from acrylic acid or methacrylic acid, their esters, their amides or their salts, itaconic acid, its esters, its amides or its salts, and styrene and its derivatives.

11. The composition as claimed in claim 1, wherein the (meth)acrylic polymer is poly(methyl methacrylate) and the copolymer including units resulting from a monomer (A) is methyl methacrylate.

12. A method for modifying one or more of the following properties of a (meth)acrylic polymer: its creep strength, in particular at more than 25° C., its glass transition temperature (Tg), its Vicat softening point, its adhesion to metal surfaces, such as surfaces made of steel or aluminum, its elongation at break, in particular at more than 25° C., its melt strength or melt elongational viscosity, its chemical resistance, its processability, its surface hardness, its scratch resistance, its thermal stability, or its resistance in stress cracking tests, comprising the step of mixing said (meth)acrylic polymer with a copolymer carrying associative groups as described in claim 1.

13. An item selected from the group consisting of: components or parts of passenger compartments of motor vehicles, such as signal lights or dashboards, in the construction and building industry, such as windows or window frames, in decoration, such as furniture or jewelry, in hygiene/health, such as bathtubs, wash basins or test tubes, in domestic electrical appliances, such as microwave oven doors or mixer bowls, in office automation and electronics, such as portable telephone screens and optical disks (DVD, CD-ROM, and the like), in lighting, such as globes and diffusers, in signing, such as signs and displays, or in the cosmetics field, for the production of bottles, wherein said item is made from the composition as claimed in claim 1.
